(19) United States
(12) Patent Application Publication
(10) Pub. No.: US 2016/0085322 A1
(43) Pub. Date: Mar. 24, 2016

(54) WIRELESS MOUSE, MOUSE PAD AND WIRELESS MOUSE APPARATUS

(71) Applicant: Samsung Electro-Mechanics Co., Ltd., Suwon-si (KR)

(72) Inventors: Sung Heum PARK, Suwon-si (KR); Sang Ho CHO, Suwon-si (KR); Ki Won CHANG, Suwon-si (KR); Duk Won SEO, Suwon-si (KR); Jae Suk SUNG, Suwon-si (KR); Hyung Wook CHO, Suwon-si (KR); Chang Mok HAN, Suwon-si (KR)

(73) Assignee: Samsung Electro-Mechanics Co., Ltd., Suwon-si (KR)

(21) Appl. No.: 14/664,666

(22) Filed: Mar. 20, 2015

(30) Foreign Application Priority Data
Sep. 24, 2014 (KR) 10-2014-0127924

(51) Int. Cl. G06F 3/0354; G06F 1/26; H02J 7/02; G06F 3/039

(52) U.S. Cl. CPC G06F 3/03543; G06F 3/0395; G06F 1/26; H02J 7/025

(57) ABSTRACT

There are provided a wireless mouse including: a charging unit receiving power in a non-contact manner to charge a battery with the received power; a movement detection unit detecting movements of the wireless mouse made by a user; and a controlling unit controlling whether or not a charging operation of the charging unit is performed, depending on the movements of the wireless mouse, a mouse pad including: a pad body having a predetermined area; a charging region provided on a portion of a surface of the pad body and transmitting power in a non-contact manner; and an operating region provided on the remainder of the surface of the pad body to be separated from the charging region and assisting in a pointing operation of the mouse, and a wireless mouse apparatus including the wireless mouse and the mouse pad.

### CROSS-REFERENCE TO RELATED APPLICATION

This application claims priority to, and the benefit of, Korean Patent Application No. 10-2014-0127924 filed on Sep. 24, 2014, with the Korean Intellectual Property Office, the disclosure of which is incorporated herein by reference.

### BACKGROUND

The present disclosure relates to a wireless mouse that receives power in a non-contact manner, a mouse pad that transmits power in a non-contact manner, and a wireless mouse apparatus including a wireless mouse and a mouse pad.

Recently, a commonly used mouse apparatus, which may include a mouse and a mouse pad, has a structure in which information regarding movements of the mouse is transferred to a computer using wireless communications by mounting a transmitter in the mouse and connecting a receiver to a computer, without the mouse and the computer being connected to each other via a cable.

Such a wireless mouse requires a power supply for operating both a sensor part for sensing the movements of the mouse and a transmitter for transmitting a signal sensed by the sensor part.

However, since the wireless mouse according to the related art continuously consumes battery power, such a mouse may be problematic, in that batteries used therein should be frequently exchanged.

In addition, since a wireless mouse having a rechargeable battery embedded therein needs to be provided with separate charging cables, connectors, and the like, it is inconvenient to use such a mouse during recharging thereof, and functionality thereof as the wireless mouse may be greatly diminished. As a result, since the burden of charging costs may be aggravated for consumers and the ability to use a computer may be diminished during a charging time, may be inconvenience in the use thereof.

In addition, when a wireless mouse is used during charging thereof, an instantaneous current flowing to the wireless mouse is insufficient, a transmission function of the wireless mouse may be lost.

In order to solve the foregoing problems of wireless mouse apparatuses, as described above, a wireless mouse and a mouse pad, receiving and transmitting power in a non-contact manner as described in the following Related Art Document have been disclosed. However, there are problems that a control related to a coil hopping may not be normally performed, due to a power transmission and reception ping period undertaken in the non-contact manner, which may be significantly slower than a communications speed of the wireless mouse, and interference may occur between a communications frequency of the wireless mouse and a communications frequency for transmitting power in the non-contact manner, which may lead to communications problems.

### Related Art Document

(Patent Document 1) Korean Patent Laid-Open Publication No. 10-2008-0096917

### SUMMARY

An aspect of the present disclosure may provide a wireless mouse, a mouse pad, and a wireless mouse apparatus capable of performing a power charging operation even during operating of the wireless mouse.

According to an aspect of the present disclosure, a wireless mouse may include: a charging unit receiving power in a non-contact manner to charge a battery with the received power; a movement detection unit detecting the movements of the wireless mouse; and a controlling unit controlling whether or not a charging operation of the charging unit is performed, depending on the movements of the wireless mouse, a mouse pad may include: a pad body having a predetermined area; a charging region provided on a portion of a surface of the pad body and transmitting power to a mouse in a non-contact manner; and an operating region provided on the remainder of the surface of the pad body to be separated from the charging region and assisting in a pointing operation of the mouse, and a wireless mouse apparatus may include the wireless mouse and the mouse pad.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic configuration diagram of a wireless mouse apparatus according to an exemplary embodiment of the present disclosure;

FIG. 2 is a schematic block diagram of the wireless mouse apparatus according to an exemplary embodiment of the present disclosure;

FIG. 3 is a schematic outside view of a wireless mouse according to an exemplary embodiment of the present disclosure;

FIG. 4 is a schematic block diagram of a wireless mouse apparatus according to another exemplary embodiment of the present disclosure; and

FIG. 5 is a schematic configuration diagram of a mouse pad according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

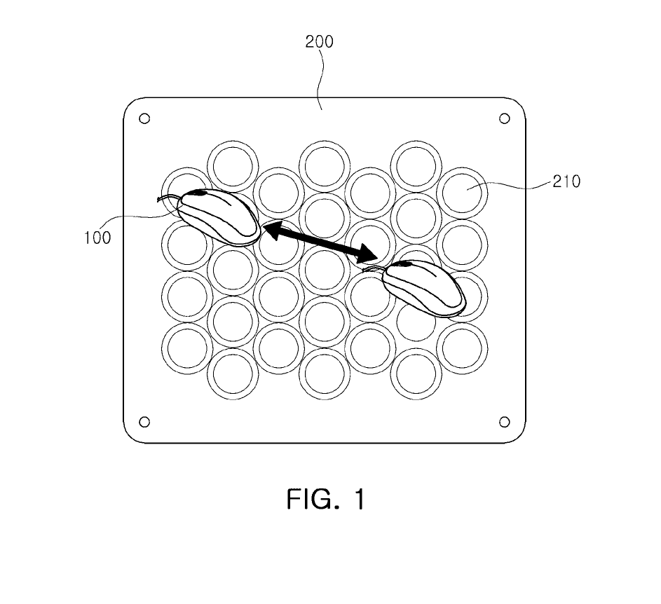

FIG. 1 is a schematic configuration diagram of a wireless mouse apparatus according to an exemplary embodiment of the present disclosure.

Referring to FIG. 1, a wireless mouse apparatus according to an exemplary embodiment of the present disclosure may include a wireless mouse 100 and a mouse pad 200.

The mouse pad 200 may include a power transmitting coil 210 transmitting power in a non-contact manner, and the wireless mouse 100 may be moved on one surface of the mouse pad 200 according to user movements and may receive the power from the power transmitting coil 210 of the mouse pad 200 in the non-contact manner (here, the non-contact manner may mean a type of power transmission manner in which the power is transmitted while not passing through a direct connection between conductors of a transmitting side and a receiving side in a process in which the power is transmitted from the transmitting side to the receiving side, and in other words, a contact-less manner, a wireless transmission manner, or the like.).

The power transmitting coil 210 of the mouse pad 200 may be provided in plural.

In this case, since a power transmission and reception ping period of the non-contact manner is very slower than communications speed of the wireless mouse, a control about a coil hopping may not be normally performed, and since interference occurs between a communications frequency of the wireless mouse and a communications frequency for transmitting the power in the non-contact manner, communications problem may also be caused.

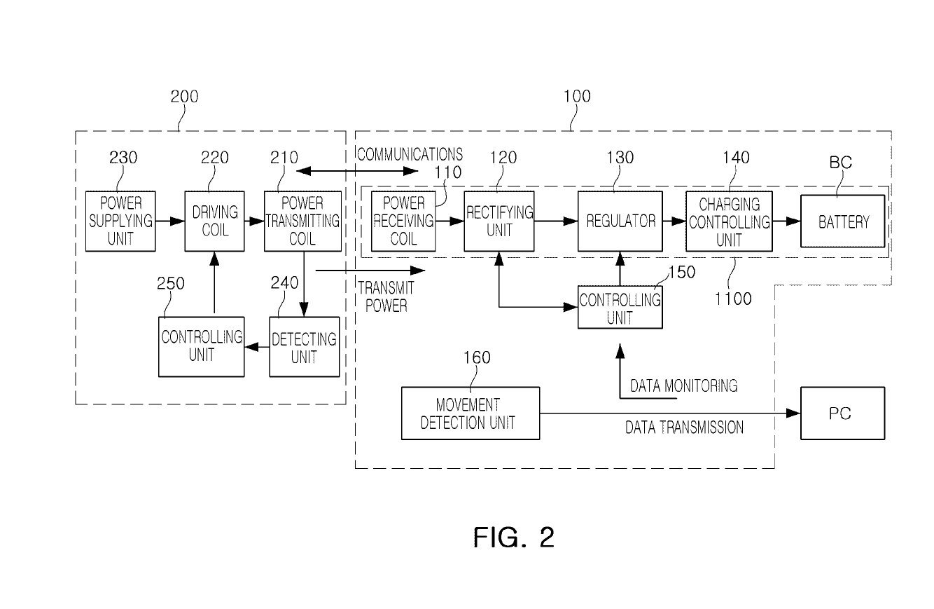

FIG. 2 is a schematic block diagram of the wireless mouse apparatus according to an exemplary embodiment of the present disclosure.

Referring to FIG. 2, the wireless mouse 100 according to an exemplary embodiment of the present disclosure may include a charging unit 1100 charging a battery BC with power, a controlling unit 150, and a movement detection unit 160.

The charging unit 1100 may charge the battery BC with the power that is received in the non-contact manner.

The charging unit 1100 may include a power receiving coil 110, a rectifying unit 120, a regulator 130, and a charging controlling unit 140.

The power receiving coil 110 may receive the power from the power transmitting coil 210 of the mouse pad 200 in the non-contact manner.

Since the power transmitted to the power receiving coil 110 may be alternating current power, the rectifying unit 120 may rectify the power from the power receiving coil 110.

The regulator 130 may appropriately regulate and output the rectified power to chargeable power by switching the power rectified by the rectifying unit 120 and regulating a voltage or current level.

The charging controlling unit 140 may control the voltage or current level of the power charged in the battery BC by transferring the regulated power from the regulator 130 to the battery BC according to the control.

The controlling unit 150 may control an operation of the charging unit 1100.

More specifically, the controlling unit 150 may control an operation about an overall charging of the charging unit 1100 and may control whether or not the charging operation of the charging unit 1100 is performed according to the movements of the wireless mouse.

For example, in the case in which there are user movements using the wireless mouse, the controlling unit 150 may stop the charging operation of the charging unit 1100, and in the case in which there are no user movements using the wireless mouse, the controlling unit 150 may resume the charging operation of the charging unit 1100.

The movement detection unit 160 may detect the motion of the wireless mouse by the user and transfer the detection result to the controlling unit 150, and the controlling unit 150 may control whether or not the charging operation of the charging unit 1100 is performed according to the detection result.

For example, in the case in which there are user movements using the wireless mouse, the controlling unit 150 may stop a rectifying operation of the rectifying unit 120 or a power regulating operation of the regulator 130, and in the case in which there are no user movements using the wireless mouse, the controlling unit 150 may resume the rectifying operation of the rectifying unit 120 or the power regulating operation of the regulator 130.

The movement detection unit 160 may detect the motion of the wireless mouse by the user and transmit the detection result to a computer PC, to perform a pointing operation of the wireless mouse.

For example, the movement detection unit 160 may emit light at a predetermined period, may perform a pointing operation based on received light when the emitted light is reflected by the mouse pad and is then received, and may detect that there is the motion of the wireless mouse performed by the user when the pointing operation is performed.

By the configuration of the wireless mouse 100 described above, the wireless mouse 100 according to the present disclosure may receive or may not receive the power transmission in the non-contact manner by determining whether or not the user uses the wireless mouse depending on the pointing operation.

The mouse pad 200 may transmit the power to the wireless mouse 100 in the non-contact manner, and may include a power transmitting coil 210, a driving unit 220, a power supplying unit 230, a detecting unit 240, and a controlling unit 250.

The power transmitting coil 210 may transmit the power to the outside in the non-contact manner, and the driving unit 220 may drive the power transmitting coil 210 so that the power transmitting coil 210 may transmit the power to the outside in the non-contact manner by switching the input power.

The power supplying unit 230 may supply the power to the driving unit 220. For example, the power supplying unit 230 may convert alternating current power into direct current power to supply the converted power to the driving unit 220, or may properly regulate the input direct current power to supply the regulated power to the driving unit 220.

The detecting unit 240 may detect a power state from the power transmitting coil 210 and transfer the detection result to the controlling unit 250. The power state from the power transmitting coil 210 may be a state of power transmitted to the outside, and may represent a level variation according to the power state transferred to the power receiving coil 110 of the wireless mouse 100. In addition, the power state from the power transmitting coil 210 may represent a level variation according to a communications signal transferred from the power receiving coil 110 of the wireless mouse 100.

The controlling unit 250 may control a power level transmitted through the power transmitting coil 210 by controlling the switching of the driving unit 220 according to the detection result from the detecting unit 240.

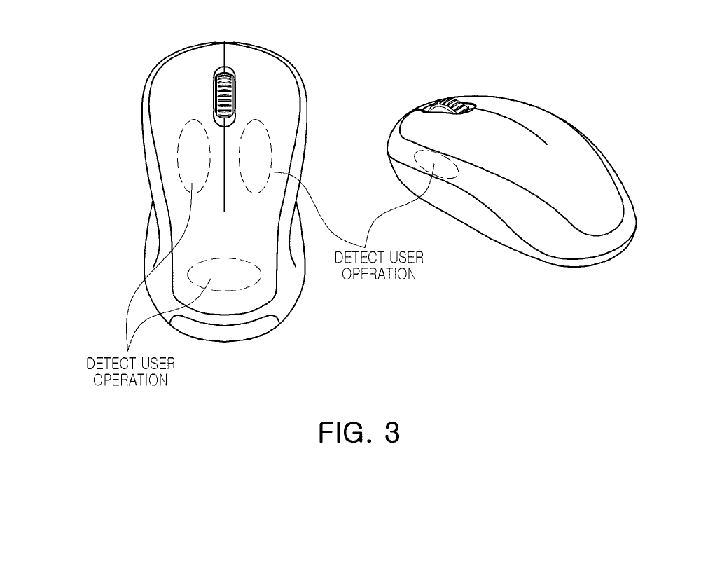

FIG. 3 is a schematic outside view of a wireless mouse according to an exemplary embodiment of the present disclosure.

Referring to FIG. 3, the wireless mouse according to the present disclosure may receive the power that is transmitted in the non-contact manner or perform the pointing operation without receiving the power, by determining whether or not the user uses the wireless mouse.

In order to detect whether or not the user uses the wireless mouse, the wireless mouse may detect from a case of the wireless mouse that the user holds the wireless mouse in order to use the wireless mouse, or that the user performs a click operation using the wireless mouse.

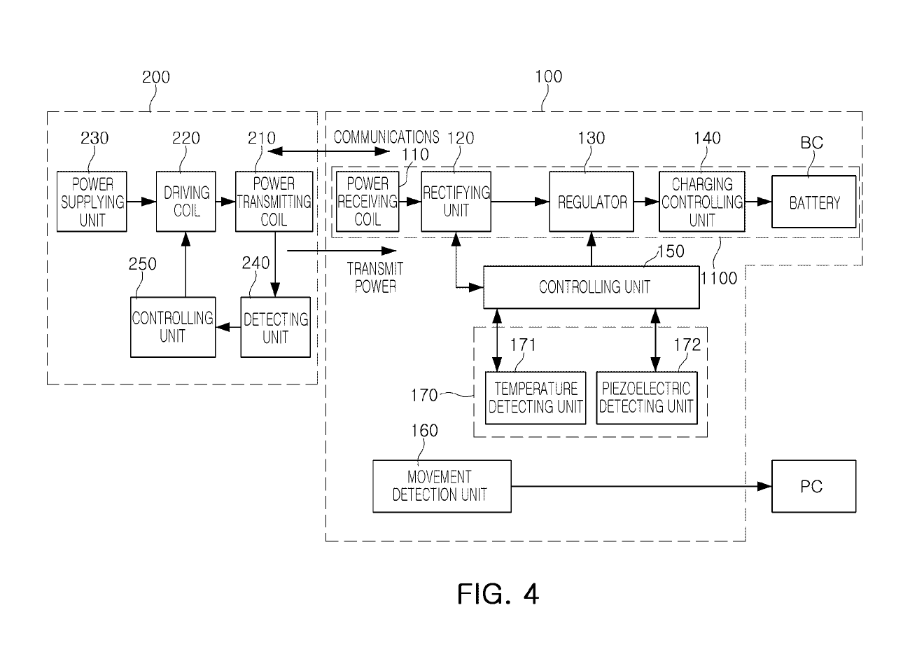

FIG. 4 is a schematic block diagram of a wireless mouse apparatus according to another exemplary embodiment of the present disclosure.

Referring to FIG. 4, the mouse pad may transmit the power to the wireless mouse 100 in the non-contact manner as described with respect to FIG. 2, and the mouse pad 200 may include the power transmitting coil 210, the driving unit 210, the power supplying unit 230, the detecting unit 240, and the controlling unit 250.

The configuration and operation of the mouse pad 200 described above are the same as those of the description with respect to FIG. 2.

Next, the wireless mouse 100 may include the charging unit 1100 charging the battery BC with power, the controlling unit 150, and the movement detection unit 160, as described with respect to FIG. 2, and the wireless mouse 100 may further include a user operation detecting unit 170.

The configuration and operation of the charging unit 1100 and the controlling unit 150 of the components of the wireless mouse 100 are same as or similar to those described above, a description thereof will be omitted.

The movement detection unit 160 may emit light at a predetermined period, may detect a motion of the wireless mouse by the user based on received light when the emitted light is reflected by the mouse pad and is then received, and may transmit the detection result to a computer PC, to perform a pointing operation of the wireless mouse.

The user operation detecting unit 170 may include at least one of a temperature detecting unit 171 and a piezoelectric detecting unit 172.

When the user holds the case of the wireless mouse 100, the temperature detecting unit 171 may detect temperature of the case or portions adjacent to the case. When the detection result from the temperature detecting unit 171 has a level of a corresponding temperature or more, the controlling unit 150 may determine that the user holds the wireless mouse 100 and consequently, stop the reception of power transmitted in the non-contact manner by the charging unit 1100.

In addition, when the user holds the case of the wireless mouse 100, the piezoelectric detecting unit 172 may detect pressure that the user holds the wireless mouse 100. When the detection result from the piezoelectric detecting unit 172 has a level of a corresponding pressure or more, the controlling unit 150 may determine that the user holds the wireless mouse 100 and consequently, stop the reception of power transmitted in the non-contact manner by the charging unit 1100.

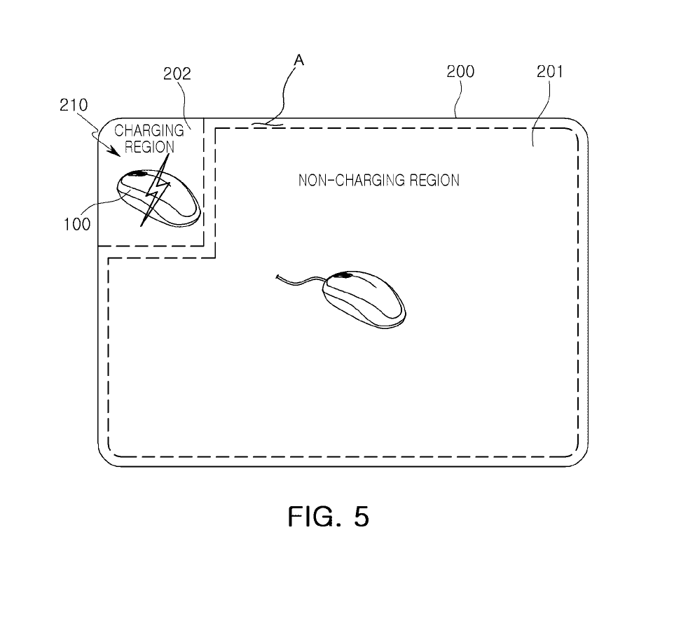

FIG. 5 is a schematic configuration diagram of a mouse pad according to an exemplary embodiment of the present disclosure.

Referring to FIG. 5, the mouse pad 200 according to the present disclosure may include an operating region 201 and a charging region 202.

The mouse pad 200 may include a pad body A having a predetermined area, the charging region 202 may be formed on a portion of one surface of the pad body A to transmit the power in the non-contact manner, and the operating region 201 may be formed on the remainder of one surface of the pad body A to be separated from the charging region 202 and may assist the pointing operation of the wireless mouse 100. Therefore, the operating region 201 may be a non-charging region.

According to those described above, the user may perform the pointing operation using the wireless mouse 100 on the non-charging region 201 of the mouse pad 200 at the time of the use of the wireless mouse 100, and may receive the power from the power transmitting coil 210 included in the pad body A of the charging region 202 in the non-contact manner to charge the battery therein with power by positioning the wireless mouse 100 on the charging region 202 of the mouse pad 200 in the case in which the use of the wireless mouse ends or the charging of the wireless mouse is required.

As described above, according to the present disclosure, since the power charging operation is performed depending on whether or not the user uses the wireless mouse, the pointing operation and the power charging operation of the wireless mouse may be normally operated.

As set forth above, according to exemplary embodiments of the present disclosure, since the coil-hopping is normally performed, the pointing operation and the power charging operation of the wireless mouse may be normally operated.

While exemplary embodiments have been shown and described above, it will be apparent to those skilled in the art that modifications and variations could be made without departing from the scope of the present invention as defined by the appended claims.

What is claimed is:

1. A wireless mouse transmitting location data depending on movements thereof made by a user, the wireless mouse comprising:
a charging unit receiving power in a non-contact manner to charge a battery with the received power;
a movement detection unit detecting the movements of the wireless mouse; and
a controlling unit controlling whether or not a charging operation of the charging unit is performed, depending on the movements of the wireless mouse.

2. The wireless mouse of claim 1, wherein the controlling unit stops the charging operation of the charging unit when the movements of the wireless mouse are detected, and resumes the charging operation of the charging unit when the movements of the wireless mouse are not detected.

3. The wireless mouse of claim 1, wherein the charging unit includes:
a power receiving coil receiving power in the non-contact manner;
a rectifying unit rectifying the power received from the power receiving coil;
a regulator regulating the rectified power to charging power that enables the battery to be charged; and
a charging controlling unit controlling the charging power from the regulator to be charged in the battery.

4. The wireless mouse of claim 3, wherein the controlling unit controls the charging operation by controlling whether or not at least one of the rectifying unit and the regulator is operated.

5. The wireless mouse of claim 1, further comprising a user operation detecting unit determining whether or not the user is operating the mouse.

6. The wireless mouse of claim 5, wherein the user operation detecting unit includes at least one of a temperature detecting unit sensing user contact by detecting temperature and a piezoelectric detecting unit sensing user contact by detecting pressure.

7. A mouse pad comprising:
a pad body having a predetermined area;
a charging region provided on a portion of a surface of the pad body and transmitting power to a mouse in a non-contact manner; and
an operating region provided on the remainder of the surface of the pad body to be separated from the charging region and assisting in a pointing operation of the mouse.

8. The mouse pad of claim 7, wherein the operating region is a non-charging region.

9. A wireless mouse apparatus comprising:
a wireless mouse transmitting location data depending on movements thereof made by a user and receiving power in a non-contact manner depending on whether or not the movements of the wireless mouse are made;
a mouse pad transmitting power to the wireless mouse in the non-contact manner.

10. The wireless mouse apparatus of claim 9, wherein the wireless mouse includes:
a charging unit receiving the power in the non-contact manner to charge a battery with the received power;
a movement detection unit detecting the movements of the wireless mouse; and
a controlling unit controlling whether or not a charging operation of the charging unit is performed, depending on the movements of the wireless mouse.

11. The wireless mouse apparatus of claim 10, wherein the controlling unit stops the charging operation of the charging unit when the movements of the wireless mouse are detected, and resumes the charging operation of the charging unit when the movements of the wireless mouse are not detected.

12. The wireless mouse apparatus of claim 10, wherein the charging unit includes:
a power receiving coil receiving the power in the non-contact manner;
a rectifying unit rectifying the power received from the power receiving coil;
a regulator regulating the rectified power to charging power that enables the battery to be charged; and
a charging controlling unit controlling the charging power from the regulator to be charged in the battery.

13. The wireless mouse apparatus of claim 12, wherein the controlling unit controls the charging operation by controlling whether or not at least one of the rectifying unit and the regulator is operated.

14. The wireless mouse apparatus of claim 9, wherein the wireless mouse further includes a user operation detecting unit determining whether or not the user is operating the mouse.

15. The wireless mouse apparatus of claim 14, wherein the user operation detecting unit includes at least one of a temperature detecting unit sensing user contact by detecting temperature and a piezoelectric detecting unit sensing user contact by detecting pressure.

16. The wireless mouse apparatus of claim 9, wherein the mouse pad includes:
a pad body having a predetermined area;
a charging region provided on a portion of a surface of the pad body and transmitting the power to the wireless mouse in the non-contact manner; and
an operating region provided on the remainder of the surface of the pad body to be separated from the charging region and assisting in a pointing operation of the wireless mouse.

17. The wireless mouse apparatus of claim 16, wherein the operating region is a non-charging region.
